(19) United States
(12) Patent Application Publication
(10) Pub. No.: US 2010/0140417 A1
(43) Pub. Date: Jun. 10, 2010

(54) Modification of a NASA 4412 airfoil's upper surface produces increased lift

(76) Inventors: Phillip Rush Bose, Pleasant Hill, CA (US); Marilee Anne Nelson, Placerville, CA (US)

Correspondence Address: Phillip R. Bose, 2088 Ahneita Drive, Pleasant Hill, CA, 94523, US

(21) Appl. No.: 12/315,638

(22) Filed: Dec. 5, 2008

(51) Int. Cl. B64C 3/14

(52) U.S. Cl. 244/35 R

(57) ABSTRACT

A measurable increase in lift has been discovered by modifying the top surface of a NASA 4412 airfoil. This modification has been demonstrated in a straight wing of a typical plane and a similar circular wing as used in U.S. Pat. No. 5,046,685. the listed ordinates have not been optimized for any particular air speed. These results will benefit ultra-lites, gliders, helicopters or any slow flying aircraft.

TABLE 1
Profile Ordinates

| | | | | Bose, Nelson Modified (2) | | | |
|---|---|---|---|---|---|---|---|
| NACA 4412 (1) | | | | NACA 4412 | | | |
| Upper Surface | | Lower Surface | | Upper Surface | | Lower Surface | |
| Station | Ordinate (3) | Station | Ordinate (3) | Station | Ordinate (2) | Station | Ordinate (3) |
| 0 | 0 | 0 | 0 | 0 | 0 | 0 | 0 |
| 1.25 | 2.44 | 1.25 | −1.43 | 1.25 | 2.44 | 1.25 | −1.43 |
| 2.50 | 3.39 | 2.50 | −1.95 | 2.50 | 3.39 | 2.5 | −1.95 |
| 5.0 | 4.73 | 5.0 | −2.49 | 5.0 | 4.73 | 5.0 | −2.49 |
| 7.5 | 5.76 | 7.5 | −2.74 | 7.5 | 5.76 | 7.5 | −2.74 |
| 10.0 | 6.59 | 10.0 | −2.86 | 10.0 | 6.59 | 10.0 | −2.86 |
| 15 | 7.89 | 15 | By connecting this | 15 | 7.98 | 15 | By connecting this |
| 20 | 8.80 | 20 | point to the 100% | 20 | 8.80 | 20 | point to the 100% |
| 25 | 9.41 | 25 | chord provides a flat | 25 | 9.41 | 25 | chord provides a flat |
| 30 | 9.76 | 30 | under-surface to the airfoil. | 30 | 9.76 | | under-surface to the airfoil. |
| | | | | 38.5 | 7.5 | 30 | |
| 40 | 9.80 | 40 | | 40 | 6.2, 7.5, 9.0 | 40 | |
| 50 | 9.19 | 50 | | 50 | 5.8, 9.19 | 50 | |
| 60 | 8.14 | 60 | | 60 | 5.0 | 60 | |
| 70 | 6.69 | 70 | | 70 | 4.0 | 70 | |
| 80 | 4.89 | 80 | | 80 | 2.8 | 80 | |
| 90 | 2.71 | 90 | | 90 | 1.6 | 90 | |
| 95 | 1.47 | 95 | | 95 | 1.47 | 95 | |
| 100 | (0.13) | 100 | | 100 | (0.13) | 100 | |
| 100 | . . . | | | . . . | | | |

(1) Theory of Wing Sections - ABBOTT & DOEN HOFF.
(2) Not Optimized.
(3) Ordinates = Percent of chord.

### HISTORY

Typically an airfoil is designed to provide an aircraft with greater lift to load at low air speeds or at high air speeds to have greater maneuverability, i.e. SST. The above references provide these teachings.

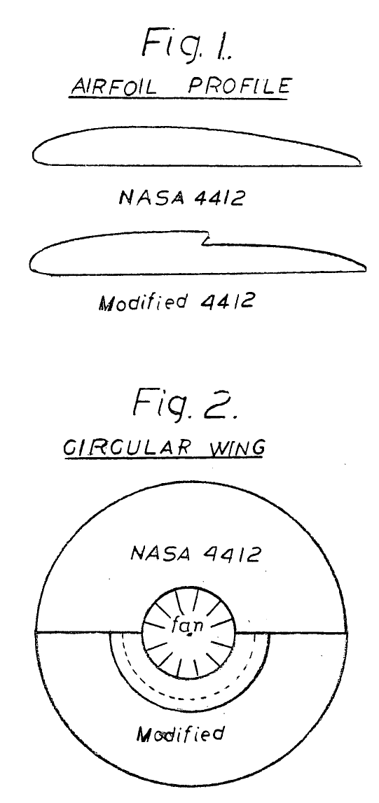

FIG. 1 illustrates the different profiles of a NASA 4412 airfoil as is or using this new modified version. The ordinates used for each profile are listed in TABLE 1. Tests of a wing section of these profiles in a small wind tunnel at an air speed of 32 mph yields a factor of four higher lift for the modified version. The addition of smoke in the air flow indicates the “COANDA” effect is not inhibited by modifying the upper surface of an airfoil.

TABLE 2
TEST RESULTS

| | Air Speed, | | | |
|---|---|---|---|---|
| Airfoil Type | MPH | Lift | | Remarks |
| NASA 4412 | 32 | 1 | gram | Wind Tunnel |
| Modified NASA 4412 | 32 | 4 | grams | Wind Tunnel |
| Modified NASA 4412 | 32 | 4 | grams | Wind Tunnel |
| NASA 4412 | 10 | <0.1 | lb | Wing Configuration |
| NASA 4412 | 20 | ~0.1 | lb | Wing Configuration |
| Modified NASA 4412 | 10 | 0.2 | lb | Wing Configuration |
| Modified NASA 4412 | 20 | 1.0 | lb | Wing Configuration |

FIG. 2 is the top view of a circular test wing four feet in diameter. The two types of airfoils were used in its construction. A motor driven fan provided the same air speeds to both upper and lower surfaces of these airfoils. The leading edge of the airfoils faced the part where the fan is located. One half of the diameter composed the NASA 4412 airfoil and the second half comprised the modified version of the NASA 4412 as described in TABLE 1. The measured lift of the two air speeds are listed in TABLE 2. The measurements were taken mid section of each half of the wing and at a point midway from the leading edge to the trailing edge. All of the above tests were made at an air temperature of 70 degrees F. and with the angle of attack of 9 percent.

### TEACHINGS

The listed ordinates were not optimized for any particular air speed. However, increased lift was detectable and measurable using the modified NASA 4412 at two low air speeds. This discovery points other airfoils may contain possibilities yet to be explored by this modification.

We claim:

1. Increased measurable lift at low airspeeds is obtained by modifying the upper surface of an airfoil. This has been demonstrated using the NASA 4412 airfoil as the test airfoil.

2. The COANDA effect at the upper surface of the airfoil is not inhibited as revealed in a small wind tunnel test using smoke in the air stream.

3. Air speed as low as 10 mph provided data to verify this concept as well as higher air speeds.
